(19) United States
(12) Patent Application Publication
(10) Pub. No.: US 2026/0245259 A1
(43) Pub. Date: Aug. 20, 2026

(54) METHOD, APPARATUS, AND MEDIUM FOR POINT CLOUD PROCESSING

(71) Applicants: Douyin Vision Co., Ltd., Beijing (CN); Bytedance Inc., Los Angeles, CA (US)

(72) Inventors: Yichen ZHOU, Beijing (CN); Yingzhan XU, Beijing (CN); Kai ZHANG, Los Angeles, CA (US); Li ZHANG, Los Angeles, CA (US); Xinfeng ZHANG, Beijing (CN)

(21) Appl. No.: 19/641,224

(22) Filed: Apr. 7, 2026

Related U.S. Application Data
(63) Continuation of application No. PCT/CN2024/123279, filed on Oct. 6, 2024.

(30) Foreign Application Priority Data
Oct. 7, 2023 (WO) PCT/CN2023/123272

(51) Int. Cl. G06T 9/00; G06T 9/40

(52) U.S. Cl. CPC G06T 9/002; G06T 9/40

(57) ABSTRACT

A solution for point cloud processing is provided. A method for point cloud processing is proposed. The method comprises: determining, for a conversion between a current point cloud (PC) sample of a point cloud sequence and a bitstream of the point cloud sequence, a prediction for a current feature of the current PC sample based on a current sparse PC sample of the current PC sample, a set of sparse PC samples and a set of features of at least one reference PC sample of the current PC sample; and performing the conversion based on the prediction for the current feature.

### CROSS REFERENCE TO RELATED APPLICATIONS

This application is a continuation of International Application No. PCT/CN2024/123279, filed on Oct. 6, 2024, which claims the benefit of International Application No. PCT/CN2023/123272, filed on Oct. 7, 2023. The entire contents of these applications are hereby incorporated by reference in their entireties.

### FIELDS

Embodiments of the present disclosure relates generally to point cloud processing techniques, and more particularly, to dynamic point cloud coding based on a reference frame.

### BACKGROUND

A point cloud is a collection of individual data points in a three-dimensional (3D) plane with each point having a set coordinate on the X, Y, and Z axes. Thus, a point cloud may be used to represent the physical content of the three-dimensional space. Point clouds have shown to be a promising way to represent 3D visual data for a wide range of immersive applications, from augmented reality to autonomous cars.

Point cloud coding standards have evolved primarily through the development of the well-known MPEG organization. MPEG, short for Moving Picture Experts Group, is one of the main standardization groups dealing with multimedia. In 2017, the MPEG 3D Graphics Coding group (3DG) published a call for proposals (CFP) document to start to develop point cloud coding standard. The final standard will consist in two classes of solutions. Video-based Point Cloud Compression (V-PCC or VPCC) is appropriate for point sets with a relatively uniform distribution of points. Geometry-based Point Cloud Compression (G-PCC or GPCC) is appropriate for more sparse distributions. However, coding efficiency of conventional point cloud coding techniques is generally expected to be further improved.

### SUMMARY

Embodiments of the present disclosure provide a solution for point cloud processing.

In a first aspect, a method for point cloud processing is proposed. The method comprises: determining, for a conversion between a current point cloud (PC) sample of a point cloud sequence and a bitstream of the point cloud sequence, a prediction for a current feature of the current PC sample based on a current sparse PC sample of the current PC sample, a set of sparse PC samples and a set of features of at least one reference PC sample of the current PC sample; and performing the conversion based on the prediction for the current feature.

Based on the method in accordance with the first aspect of the present disclosure, a prediction for a current feature of the current PC sample is determined based on a current sparse PC sample of the current PC sample, a set of sparse PC samples and a set of features of at least one reference PC sample of the current PC sample. Moreover, the current PC sample is coded based on the prediction for the current feature. Compared with the conventional solution, the proposed method can advantageously make full use of the information of coded PC samples, so as to reduce the redundancy between information of current PC sample and information of coded PC samples. Thereby, the coding efficiency can be improved.

In a second aspect, an apparatus for point cloud processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of a point cloud sequence which is generated by a method performed by an apparatus for point cloud processing. The method comprises: determining a prediction for a current feature of a current PC sample of a point cloud sequence based on a current sparse PC sample of the current PC sample, a set of sparse PC samples and a set of features of at least one reference PC sample of the current PC sample; and generating the bitstream based on the prediction for the current feature.

In a fifth aspect, a method for storing a bitstream of a point cloud sequence is proposed. The method comprises: determining a prediction for a current feature of a current PC sample of a point cloud sequence based on a current sparse PC sample of the current PC sample, a set of sparse PC samples and a set of features of at least one reference PC sample of the current PC sample; generating the bitstream based on the prediction for the current feature; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 is a block diagram that illustrates an example point cloud coding system that may utilize the techniques of the present disclosure;

FIG. 2 illustrates a block diagram that illustrates an example point cloud encoder, in accordance with some embodiments of the present disclosure;

FIG. 3 illustrates a block diagram that illustrates an example point cloud decoder, in accordance with some embodiments of the present disclosure;

FIG. 4 illustrates the flow of the dynamic point cloud compression based on multiple reference frames;

FIG. 5 illustrates a flowchart of a method for point cloud processing in accordance with embodiments of the present disclosure; and

FIG. 6 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

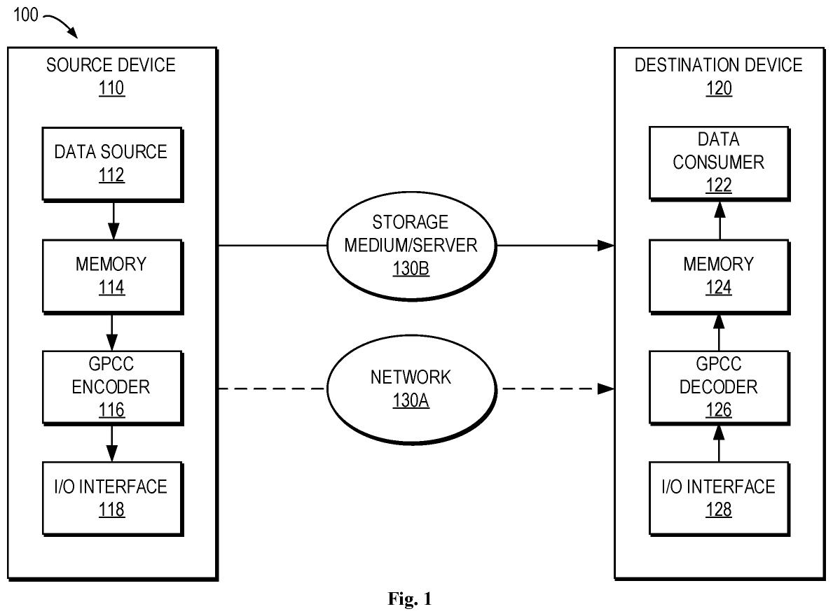

FIG. 1 is a block diagram that illustrates an example point cloud coding system 100 that may utilize the techniques of the present disclosure. As shown, the point cloud coding system 100 may include a source device 110 and a destination device 120. The source device 110 can be also referred to as a point cloud encoding device, and the destination device 120 can be also referred to as a point cloud decoding device. In operation, the source device 110 can be configured to generate encoded point cloud data and the destination device 120 can be configured to decode the encoded point cloud data generated by the source device 110. The techniques of this disclosure are generally directed to coding (encoding and/or decoding) point cloud data, i.e., to support point cloud compression. The coding may be effective in compressing and/or decompressing point cloud data.

Source device 100 and destination device 120 may comprise any of a wide range of devices, including desktop computers, notebook (i.e., laptop) computers, tablet computers, set-top boxes, telephone handsets such as smartphones and mobile phones, televisions, cameras, display devices, digital media players, video gaming consoles, video streaming devices, vehicles (e.g., terrestrial or marine vehicles, spacecraft, aircraft, etc.), robots, LIDAR devices, satellites, extended reality devices, or the like. In some cases, source device 100 and destination device 120 may be equipped for wireless communication.

The source device 100 may include a data source 112, a memory 114, a GPCC encoder 116, and an input/output (I/O) interface 118. The destination device 120 may include an input/output (I/O) interface 128, a GPCC decoder 126, a memory 124, and a data consumer 122. In accordance with this disclosure, GPCC encoder 116 of source device 100 and GPCC decoder 126 of destination device 120 may be configured to apply the techniques of this disclosure related to point cloud coding. Thus, source device 100 represents an example of an encoding device, while destination device 120 represents an example of a decoding device. In other examples, source device 100 and destination device 120 may include other components or arrangements. For example, source device 100 may receive data (e.g., point cloud data) from an internal or external source. Likewise, destination device 120 may interface with an external data consumer, rather than include a data consumer in the same device.

In general, data source 112 represents a source of point cloud data (i.e., raw, unencoded point cloud data) and may provide a sequential series of “frames” of the point cloud data to GPCC encoder 116, which encodes point cloud data for the frames. In some examples, data source 112 generates the point cloud data. Data source 112 of source device 100 may include a point cloud capture device, such as any of a variety of cameras or sensors, e.g., one or more video cameras, an archive containing previously captured point cloud data, a 3D scanner or a light detection and ranging (LIDAR) device, and/or a data feed interface to receive point cloud data from a data content provider. Thus, in some examples, data source 112 may generate the point cloud data based on signals from a LIDAR apparatus. Alternatively or additionally, point cloud data may be computer-generated from scanner, camera, sensor or other data. For example, data source 112 may generate the point cloud data, or produce a combination of live point cloud data, archived point cloud data, and computer-generated point cloud data. In each case, GPCC encoder 116 encodes the captured, pre-captured, or computer-generated point cloud data. GPCC encoder 116 may rearrange frames of the point cloud data from the received order (sometimes referred to as “display order”) into a coding order for coding. GPCC encoder 116 may generate one or more bitstreams including encoded point cloud data. Source device 100 may then output the encoded point cloud data via I/O interface 118 for reception and/or retrieval by, e.g., I/O interface 128 of destination device 120. The encoded point cloud data may be transmitted directly to destination device 120 via the I/O interface 118 through the network 130A. The encoded point cloud data may also be stored onto a storage medium/server 130B for access by destination device 120.

Memory 114 of source device 100 and memory 124 of destination device 120 may represent general purpose memories. In some examples, memory 114 and memory 124 may store raw point cloud data, e.g., raw point cloud data from data source 112 and raw, decoded point cloud data from GPCC decoder 126. Additionally or alternatively, memory 114 and memory 124 may store software instructions executable by, e.g., GPCC encoder 116 and GPCC decoder 126, respectively. Although memory 114 and memory 124 are shown separately from GPCC encoder 116 and GPCC decoder 126 in this example, it should be understood that GPCC encoder 116 and GPCC decoder 126 may also include internal memories for functionally similar or equivalent purposes. Furthermore, memory 114 and memory 124 may store encoded point cloud data, e.g., output from GPCC encoder 116 and input to GPCC decoder 126. In some examples, portions of memory 114 and memory 124 may be allocated as one or more buffers, e.g., to store raw, decoded, and/or encoded point cloud data. For instance, memory 114 and memory 124 may store point cloud data.

I/O interface 118 and I/O interface 128 may represent wireless transmitters/receivers, modems, wired networking components (e.g., Ethernet cards), wireless communication components that operate according to any of a variety of IEEE 802.11 standards, or other physical components. In examples where I/O interface 118 and I/O interface 128 comprise wireless components, I/O interface 118 and I/O interface 128 may be configured to transfer data, such as encoded point cloud data, according to a cellular communication standard, such as 4G, 4G-LTE (Long-Term Evolution), LTE Advanced, 5G, or the like. In some examples where I/O interface 118 comprises a wireless transmitter, I/O interface 118 and I/O interface 128 may be configured to transfer data, such as encoded point cloud data, according to other wireless standards, such as an IEEE 802.11 specification. In some examples, source device 100 and/or destination device 120 may include respective system-on-a-chip (SoC) devices. For example, source device 100 may include an SoC device to perform the functionality attributed to GPCC encoder 116 and/or I/O interface 118, and destination device 120 may include an SoC device to perform the functionality attributed to GPCC decoder 126 and/or I/O interface 128.

The techniques of this disclosure may be applied to encoding and decoding in support of any of a variety of applications, such as communication between autonomous vehicles, communication between scanners, cameras, sensors and processing devices such as local or remote servers, geographic mapping, or other applications.

I/O interface 128 of destination device 120 receives an encoded bitstream from source device 110. The encoded bitstream may include signaling information defined by GPCC encoder 116, which is also used by GPCC decoder 126, such as syntax elements having values that represent a point cloud. Data consumer 122 uses the decoded data. For example, data consumer 122 may use the decoded point cloud data to determine the locations of physical objects. In some examples, data consumer 122 may comprise a display to present imagery based on the point cloud data.

GPCC encoder 116 and GPCC decoder 126 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of GPCC encoder 116 and GPCC decoder 126 may be included in one or more encoders or decoders, either of which may be integrated as part of a combined encoder/decoder (CODEC) in a respective device. A device including GPCC encoder 116 and/or GPCC decoder 126 may comprise one or more integrated circuits, microprocessors, and/or other types of devices.

GPCC encoder 116 and GPCC decoder 126 may operate according to a coding standard, such as video point cloud compression (VPCC) standard or a geometry point cloud compression (GPCC) standard. This disclosure may generally refer to coding (e.g., encoding and decoding) of frames to include the process of encoding or decoding data. An encoded bitstream generally includes a series of values for syntax elements representative of coding decisions (e.g., coding modes).

A point cloud may contain a set of points in a 3D space, and may have attributes associated with the point. The attributes may be color information such as R, G, B or Y, Cb, Cr, or reflectance information, or other attributes. Point clouds may be captured by a variety of cameras or sensors such as LIDAR sensors and 3D scanners and may also be computer-generated. Point cloud data are used in a variety of applications including, but not limited to, construction (modeling), graphics (3D models for visualizing and animation), and the automotive industry (LIDAR sensors used to help in navigation).

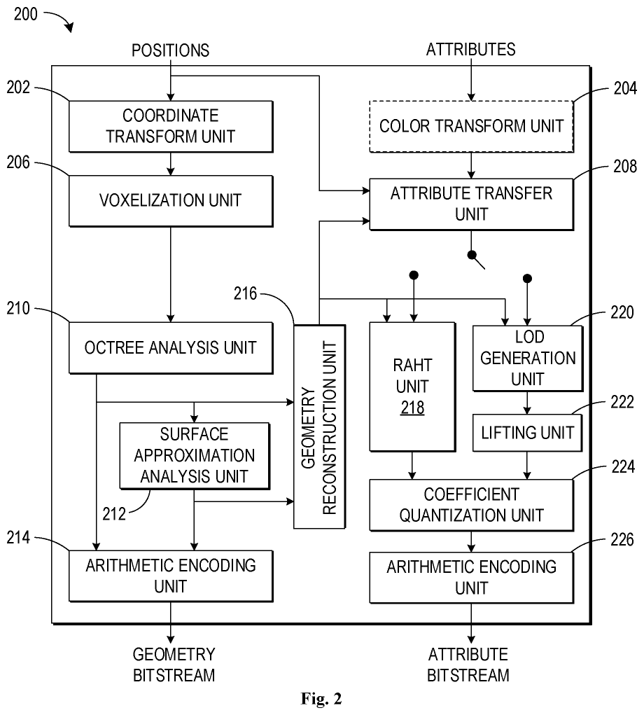

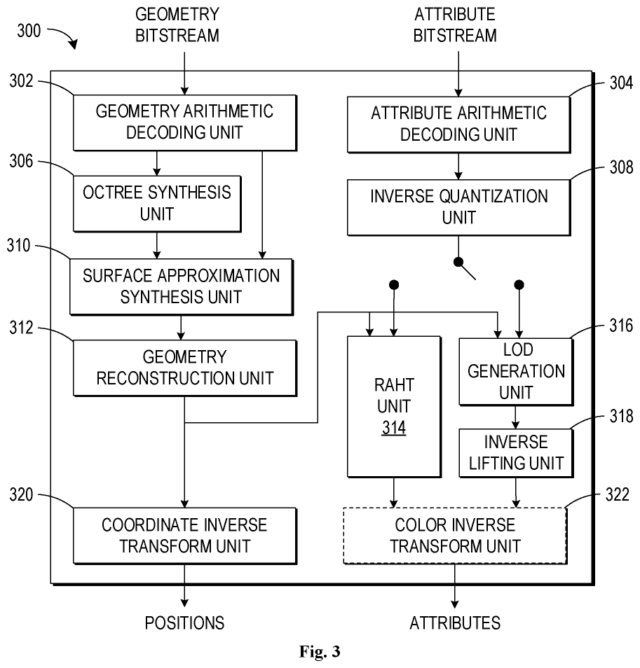

FIG. 2 is a block diagram illustrating an example of a GPCC encoder 200, which may be an example of the GPCC encoder 116 in the system 100 illustrated in FIG. 1, in accordance with some embodiments of the present disclosure. FIG. 3 is a block diagram illustrating an example of a GPCC decoder 300, which may be an example of the GPCC decoder 126 in the system 100 illustrated in FIG. 1, in accordance with some embodiments of the present disclosure.

In both GPCC encoder 200 and GPCC decoder 300, point cloud positions are coded first. Attribute coding depends on the decoded geometry. In FIG. 2 and FIG. 3, the region adaptive hierarchical transform (RAHT) unit 218, surface approximation analysis unit 212, RAHT unit 314 and surface approximation synthesis unit 310 are options typically used for Category 1 data. The level-of-detail (LOD) generation unit 220, lifting unit 222, LOD generation unit 316 and inverse lifting unit 318 are options typically used for Category 3 data. All the other units are common between Categories 1 and 3.

For Category 3 data, the compressed geometry is typically represented as an octree from the root all the way down to a leaf level of individual voxels. For Category 1 data, the compressed geometry is typically represented by a pruned octree (i.e., an octree from the root down to a leaf level of blocks larger than voxels) plus a model that approximates the surface within each leaf of the pruned octree. In this way, both Category 1 and 3 data share the octree coding mechanism, while Category 1 data may in addition approximate the voxels within each leaf with a surface model. The surface model used is a triangulation comprising 1-10 triangles per block, resulting in a triangle soup. The Category 1 geometry codec is therefore known as the Trisoup geometry codec, while the Category 3 geometry codec is known as the Octree geometry codec.

In the example of FIG. 2, GPCC encoder 200 may include a coordinate transform unit 202, a color transform unit 204, a voxelization unit 206, an attribute transfer unit 208, an octree analysis unit 210, a surface approximation analysis unit 212, an arithmetic encoding unit 214, a geometry reconstruction unit 216, an RAHT unit 218, a LOD generation unit 220, a lifting unit 222, a coefficient quantization unit 224, and an arithmetic encoding unit 226.

As shown in the example of FIG. 2, GPCC encoder 200 may receive a set of positions and a set of attributes. The positions may include coordinates of points in a point cloud. The attributes may include information about points in the point cloud, such as colors associated with points in the point cloud.

Coordinate transform unit 202 may apply a transform to the coordinates of the points to transform the coordinates from an initial domain to a transform domain. This disclosure may refer to the transformed coordinates as transform coordinates. Color transform unit 204 may apply a transform to convert color information of the attributes to a different domain. For example, color transform unit 204 may convert color information from an RGB color space to a YCbCr color space.

Furthermore, in the example of FIG. 2, voxelization unit 206 may voxelize the transform coordinates. Voxelization of the transform coordinates may include quantizing and removing some points of the point cloud. In other words, multiple points of the point cloud may be subsumed within a single “voxel,” which may thereafter be treated in some respects as one point. Furthermore, octree analysis unit 210 may generate an octree based on the voxelized transform coordinates. Additionally, in the example of FIG. 2, surface approximation analysis unit 212 may analyze the points to potentially determine a surface representation of sets of the points. Arithmetic encoding unit 214 may perform arithmetic encoding on syntax elements representing the information of the octree and/or surfaces determined by surface approximation analysis unit 212. GPCC encoder 200 may output these syntax elements in a geometry bitstream.

Geometry reconstruction unit 216 may reconstruct transform coordinates of points in the point cloud based on the octree, data indicating the surfaces determined by surface approximation analysis unit 212, and/or other information. The number of transform coordinates reconstructed by geometry reconstruction unit 216 may be different from the original number of points of the point cloud because of voxelization and surface approximation. This disclosure may refer to the resulting points as reconstructed points. Attribute transfer unit 208 may transfer attributes of the original points of the point cloud to reconstructed points of the point cloud data.

Furthermore, RAHT unit 218 may apply RAHT coding to the attributes of the reconstructed points. Alternatively or additionally, LOD generation unit 220 and lifting unit 222 may apply LOD processing and lifting, respectively, to the attributes of the reconstructed points. RAHT unit 218 and lifting unit 222 may generate coefficients based on the attributes. Coefficient quantization unit 224 may quantize the coefficients generated by RAHT unit 218 or lifting unit 222. Arithmetic encoding unit 226 may apply arithmetic coding to syntax elements representing the quantized coefficients. GPCC encoder 200 may output these syntax elements in an attribute bitstream.

In the example of FIG. 3, GPCC decoder 300 may include a geometry arithmetic decoding unit 302, an attribute arithmetic decoding unit 304, an octree synthesis unit 306, an inverse quantization unit 308, a surface approximation synthesis unit 310, a geometry reconstruction unit 312, a RAHT unit 314, a LOD generation unit 316, an inverse lifting unit 318, a coordinate inverse transform unit 320, and a color inverse transform unit 322.

GPCC decoder 300 may obtain a geometry bitstream and an attribute bitstream. Geometry arithmetic decoding unit 302 of decoder 300 may apply arithmetic decoding (e.g., CABAC or other type of arithmetic decoding) to syntax elements in the geometry bitstream. Similarly, attribute arithmetic decoding unit 304 may apply arithmetic decoding to syntax elements in attribute bitstream.

Octree synthesis unit 306 may synthesize an octree based on syntax elements parsed from geometry bitstream. In instances where surface approximation is used in geometry bitstream, surface approximation synthesis unit 310 may determine a surface model based on syntax elements parsed from geometry bitstream and based on the octree.

Furthermore, geometry reconstruction unit 312 may perform a reconstruction to determine coordinates of points in a point cloud. Coordinate inverse transform unit 320 may apply an inverse transform to the reconstructed coordinates to convert the reconstructed coordinates (positions) of the points in the point cloud from a transform domain back into an initial domain.

Additionally, in the example of FIG. 3, inverse quantization unit 308 may inverse quantize attribute values. The attribute values may be based on syntax elements obtained from attribute bitstream (e.g., including syntax elements decoded by attribute arithmetic decoding unit 304).

Depending on how the attribute values are encoded, RAHT unit 314 may perform RAHT coding to determine, based on the inverse quantized attribute values, color values for points of the point cloud. Alternatively, LOD generation unit 316 and inverse lifting unit 318 may determine color values for points of the point cloud using a level of detail-based technique.

Furthermore, in the example of FIG. 3, color inverse transform unit 322 may apply an inverse color transform to the color values. The inverse color transform may be an inverse of a color transform applied by color transform unit 204 of encoder 200. For example, color transform unit 204 may transform color information from an RGB color space to a YCbCr color space. Accordingly, color inverse transform unit 322 may transform color information from the YCbCr color space to the RGB color space.

The various units of FIG. 2 and FIG. 3 are illustrated to assist with understanding the operations performed by encoder 200 and decoder 300. The units may be implemented as fixed-function circuits, programmable circuits, or a combination thereof. Fixed-function circuits refer to circuits that provide particular functionality and are preset on the operations that can be performed. Programmable circuits refer to circuits that can be programmed to perform various tasks and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to GPCC or other specific point cloud codecs, the disclosed techniques are applicable to other point cloud coding technologies also. Furthermore, while some embodiments describe point cloud coding steps in detail, it will be understood that corresponding steps decoding that undo the coding will be implemented by a decoder.

### 1. Brief Summary

The present disclosure is related to dynamic point cloud coding technologies. Specifically, it is related to learning-based dynamic point cloud geometry compression. The ideas may be combined with point cloud coding standard, e.g., the being-developed Geometry based Point Cloud Compression (G-PCC).

### 2. Abbreviations

| | |
|---|---|
| G-PCC | Geometry based Point Cloud Compression |
| MPEG | Moving Picture Experts Group |

### 3. Introduction

In point cloud compression, traditional octree coding, grid coding, mapping coding, and attribute coding have provided the basic ideas and framework for compression. Following their encoding principles and module structures, people use various signal processing methods to design new modules or optimize and enhance the old ones. The same is true for learning-based point cloud compression, which can replace traditional modules using neural network models and also optimize model parameters based on data-driven optimization.

At present, learning-based static point cloud compression has significantly outperformed traditional compression methods, so it is desired to migrate learning-based methods to dynamic point cloud compression. In the same manner as static compression, dynamic compression also needs to preserve as much information about the point cloud in each frame as the bit rate allows. However, unlike static point cloud compression, dynamic point cloud compression needs to take into account not only intra-frame compression within a single frame, but also inter-frame compression that is the core of dynamic compression. Intra-frame prediction, using the information of the reference frame to predict the information of the current frame, is an important part of inter-frame compression. The more accurate the intra-frame prediction becomes, the more effective the intra-frame compression will be, and the lower the bit rate consumed by a single frame will be. Considering the similar correlation between neighboring frames, most dynamic point cloud compression methods use the previous frame as the reference frame to predict the current frame, and all of them achieve good prediction performance.

### 3.1 Sparse Convolution

To exploit the sparsity of point clouds, scholars have conducted many explorations, such as octree-based CNNs and sparse CNNs. For sparse CNNs, the data tensor is represented by a set of coordinates C and the associated features F. The convolution aggregates only the features that are positively occupying the coordinates. It is defined as:

$${f}_{t}^{out} = {\sum }_{i ∈ {N}^{3} ( t , {C}^{in} )} {W}_{i} {f}_{t + i}^{in}$$

$$for t ∈ {C}^{out}$$

where Cⁱⁿ and C^{out} are input coordinates and output coordinates.

$${f}_{t}^{in}$$

$$and$$

$${f}_{t}^{out}$$

are input and output feature vectors at coordinate t. N³(t, Cⁱⁿ)={i|t+i∈Cⁱⁿ, i∈N³} defines a 3D convolutional kernel, covering a set of locations centered at t with offset i's in Cⁱⁿ. Wᵢ denotes the kernel value at offset i. This sparse convolution exploits the sparsity of the point cloud to reduce the complexity and computes only on the positively occupied voxels.

### 4. Problems

The existing learning-based dynamic point cloud compression methods have the following problems:
1. The intra-frame prediction's accuracy of current dynamic point cloud compression methods is not high, resulting in a large redundancy between the current frame information to be transmitted and the reference frame information.
2. Most of the dynamic point cloud compression methods do not make full use of the information in the encoded frames, which reduces the available information for reference, resulting in redundancy between the current frame information to be transmitted and the information of the encoded frames.
3. Current learning-based dynamic point cloud compression methods only consider the balance between the bit rate of the residual of the current frame information relative to the prediction information and the quality of decoded the current frame but ignore the constraints of the prediction information, which may affect the code rate and reduce the decoding quality of the current frame current frame.

### 5. Detailed Solutions

To solve the above problems and some other problems not mentioned, methods as summarized below are disclosed. The solutions should be considered as examples to explain the general concepts and should not be interpreted in a narrow way. Furthermore, these solutions can be applied individually or combined in any manner. In the following discussions, the term “encoder” refers to the model to code of the information to be signalled. The term “decoder” refers to the model to decode the compression bits to get the signalled information.
1) It is proposed to down sample the point cloud of current frame to obtain the real sparse point cloud and corresponding real features of the current frame.
   a. In one example, sparse point clouds and corresponding features may be obtained using traditional non-learning downsampling methods.
      i. In one example, sparse point clouds and corresponding features may be obtained using furthest distance point sampling.
      ii. In one example, sparse point clouds and corresponding features may be obtained using uniform sampling.
   b. In one example, sparse point clouds and corresponding features may be obtained using learning-based downsampling methods.
      i. In one example, a neural network-based downsampling approach may be used to obtain the sparse point clouds and corresponding features.
         1. In one example, sparse point clouds and corresponding features can be obtained through a multi-stage downsampling network.
         a. In one example, the number of stages may be N. For example, N is equal to 3.
         2. In one example, sparse point clouds and corresponding features of any stage in the multi-stage downsampling network may be output.
         a. In one example, the sparse point cloud and corresponding features of the last stage in the multi-stage downsampling network may be used as the real sparse point cloud and corresponding real features of the current frame.
         3. In one example, sparse point clouds and corresponding features of all stages in the multi-stage downsampling network can be output.
         4. In one example, the sparse convolution may be used as the basic operation in the convolutional network.
         a. In one example, the step size of sparse convolution may be N. For example, N is equal to 2.
         b. In one example, N may be pre-defined.
         c. In one example, N may be siganlled.
2) It is proposed to down sample the point cloud of reference frames to obtain the reference sparse point cloud and reference features.
   a. In one example, the reference frame point cloud may be a frame point cloud or multiple frame point clouds before the current frame point cloud.
      i. In one example, the reference frame point cloud may be the point clouds of the previous two frames of the current frame.
   b. In one example, the reference sparse point clouds and reference features may be obtained using learning-based downsampling methods.
      i. In one example, a neural network-based downsampling approach may be used to obtain the reference sparse point clouds and reference features.
         1. In one example, reference sparse point clouds and reference features may be obtained through a multi-stage downsampling network.
         a. In one example, the number of stage may be N. For example, N is equal to 3.
         2. In one example, the reference sparse point clouds and reference features of any one stage in the multi-stage downsampling network may be output.
         3. In one example, the reference sparse point clouds and reference features of any stages in the multi-stage downsampling network may be output.
         a. In one example, the reference sparse point clouds and reference features of the last two stages in the multi-stage downsampling network can be used as the reference sparse point clouds and reference features of the reference frames.
         4. In one example, the reference sparse point clouds and reference features of all stages in the multi-stage downsampling network can be output.
         5. In one example, the sparse convolution may be used as the basic operation in the convolutional network.
         a. In one example, the step size of sparse convolution may be N. For example, N is equal to 2.
         b. In one example, N may be pre-defined.
         c. In one example, N may be siganlled.
3) It is proposed to predict the features of current frame using the the reference sparse point clouds and reference features.
   a. In one example, the sparse point cloud and features of one reference frame are used to predict the features of the current frame.
      i. In one example, features of the current frame may be predicted using the sparse point cloud and features of the reference frame in the last stage.
         1. In one example, features of the current frame may be directly predicted using the sparse point cloud and features of the last stage of the reference frame.
         2. In one example, the sparse point cloud and features of the last stage of the reference frame may be used to perform refined secondary predictions of the features of the current frame.
         a. In one example, an initial prediction of the current frame features may be made using the sparse point cloud and features of the last stage of the reference frame.
         b. In one example, the first prediction features of the current frame and the features of the reference frame may be used to perform secondary prediction on the features of the current frame.
         c. In one example, feature prediction of the current frame may be accomplished using neural network-based methods.
         i. In one example, the sparse convolution and sparse convolution on target coordinates may be used as the basic operation in the convolutional network.
         3. In one example, a neural network-based prediction approach may be used to predict features of the current frame.
      ii. In one example, features of the current frame may be predicted using multi-stage sparse point clouds and features of the reference frame.
         1. In one example, multi-stage sparse point clouds and features of the reference frame may be aligned to the next stage point cloud through downsampling and fused with the aligned features until downsampling to the final stage.
         2. In one example, the prediction of the current frame features may be completed by using the fused last-stage features of the reference frame.
         3. In one example, feature prediction of the current frame may be accomplished using neural network-based methods.
         a. In one example, the sparse convolution and sparse convolution on target coordinates may be used as the basic operation in the convolutional network.
   b. In one example, the sparse point clouds and features of multi-reference frames may be used to predict the features of the current frame.
      i. In one example, the sparse point clouds and features of the two-frame reference frame may be used to predict the features of the current frame.
         1. In one example, features of the current frame may be directly predicted using the sparse point clouds and features of the last stage of the reference frames.
         a. In one example, sparse point clouds and features of the first reference frame and the second reference frame may be fused.
         b. In one example, the fused features may be used to predict the features of the current frame.
         2. In one example, the sparse point cloud and features of the last stage of the reference frame may be used to perform refined secondary predictions of the features of the current frame.
         a. In one example, the features of the current frame may be directly predicted using the first reference frame.
         b. In one example, the features of the current frame may be directly predicted using the second reference frame.
         c. In one example, features predicted using two reference frames may be fused.
         d. In one example, the fused features can be used to predict the current frame again.
         3. In one example, features of the current frame may be predicted using multi-stage sparse point clouds and features of the reference frames.
         a. In one example, multi-stage sparse point clouds and features of the reference frame may be aligned to the next stage point cloud through downsampling and fused with the aligned features until downsampling to the final stage.
         b. In one example, the prediction of the current frame features may be completed by using the fused last-stage features of the reference frame.
         c. In one example, feature prediction of the current frame may be accomplished using neural network-based methods.
4) It is proposed to code and signal the sparse point cloud of the current frame to the decoder.
   a. In one example, the sparse point cloud of the current frame may be coded by point cloud codec.
      i. In one example, the point cloud codec may be G-PCC, V-PCC, Draco etc.
5) It is proposed to code and signal the residual between the predicted features and the true features of the current frame to the decoder.
   a. In one example, the features may be coded with fixed-length coding, unary coding, truncated unary coding, etc. al.
   b. In one example, the features may be coding in a predictive way.
6) It is proposed to reconstruct point cloud of the current frame based on the acquired features and coordinates of the sparse point cloud of the current frame.
   a. In one example, the accurate features of the current frame may be obtained by adding the features of the current frame predicted based on the reference frames and the residuals of the features decoded by the decoder.
   b. In one example, the acquired accurate features of the current frame may be used for upsampling reconstruction.
   c. In one example, the reconstructed point cloud of the current frame may be obtained directly by up-sampling in one time.
   d. In one example, the reconstructed point cloud of the current frame may be obtained directly by multiple progressive up-sampling.
      i. In one example, the point cloud of the current frame may be reconstructed using N up-sampling operations, such as N=3.
         1. In one example, N may be pre-defined.
         2. In one example, N may be signalled to the decoder.
         a. In one example, N may be coded with fixed-length coding, unary coding, truncated unary coding, etc. al.
      b. In one example, N may be coding in a predictive way.
   e. In one example, the sparse convolution-based generative convolution may be used to achieve point cloud up-sampling.
   f. In one example, multi-stage loss functions with different granularities may be used to constrain neural network during the training process of the up-sampling.
      i. In one example, the binary cross-entropy value may be used as the loss function in the first stage.
      ii. In one example, the numbers of points used in the loss function may be different in different stages.
      iii. In one example, the number of points used in the loss function for each staged may be indicated by at least one indication.
         1. In one example, there are 3 stages and 3 indications, M, N and K.
         a. In one example, M % points of point cloud obtained by voxel sampling from the real point cloud may be used to constrain the reconstructed point cloud in the first stage.
         b. In one example, N % points of point cloud obtained by voxel sampling from the real point cloud may be used to constrain the reconstructed point cloud in the first stage.
         c. In one example, K % points of point cloud obtained by voxel sampling from the real point cloud may be used to constrain the reconstructed point cloud in the last stage.
         d. In one example, M<N<K, such as M=12.5, N=50, K=100.
      iv. In one example, the indication may be pre-defined.
      v. In one example, the indication may be signalled.
7) Whether to and/or how to apply a method disclosed above may be signaled from encoder to decoder in a bitstream/frame/tile/slice/octree/etc.
8) Whether to and/or how to apply the disclosed methods above may be dependent on coded information, such as dimensions, colour format, colour component, slice/picture type.

### 6. EMBODIMENTS

An example of the flow for the dynamic point cloud compression method based on multiple reference frames of point clouds is as follows. Firstly, the high-resolution original point clouds of the current frame and the reference frames are passed through a learnable adaptive downsampling network to obtain sparse point cloud and corresponding features. Secondly, the obtained features of the reference frames are utilized to predict the features of the current frame. Then, the octree lossless coder and the entropy coder respectively compress the sparse point cloud coordinates of the current frame and the residual between the real features and predicted features of the current frame. Finally, the current frame is upsampled and reconstructed using the decoded sparse point cloud coordinates and corrected features.

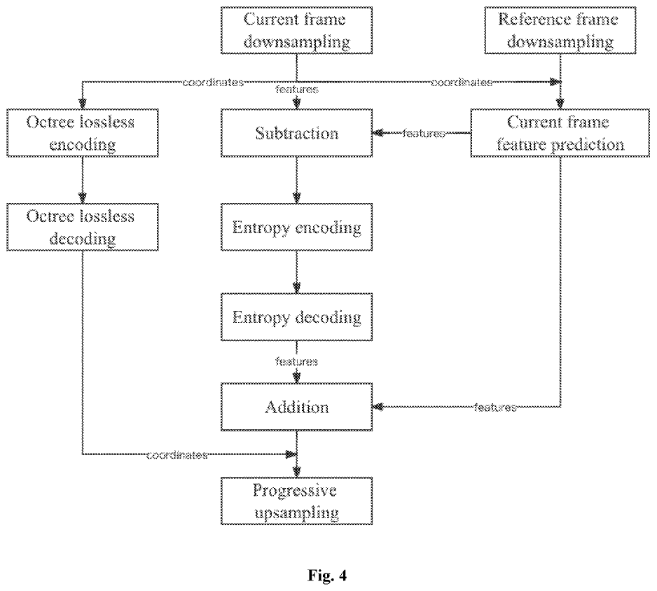

An example of the coding flow for the dynamic point cloud compression based on multiple reference frames is depicted in FIG. 4. FIG. 4 illustrates the flow of the dynamic point cloud compression based on multiple reference frames.

More details of the embodiments of the present disclosure will be described below which are related to dynamic point cloud coding based on one or more reference frames. The embodiments of the present disclosure should be considered as examples to explain the general concepts and should not be interpreted in a narrow way. Furthermore, these embodiments can be applied individually or combined in any manner.

As used herein, the term “point cloud sequence” may refer to a sequence of one or more point clouds. The term “point cloud frame” or “frame” may refer to a point cloud in a point cloud sequence. The term “point cloud (PC) sample” may refer to a frame, a sub-region within a frame, a picture, a slice, a sub-frame, a sub-picture, a tile, a segment, or any other suitable processing unit.

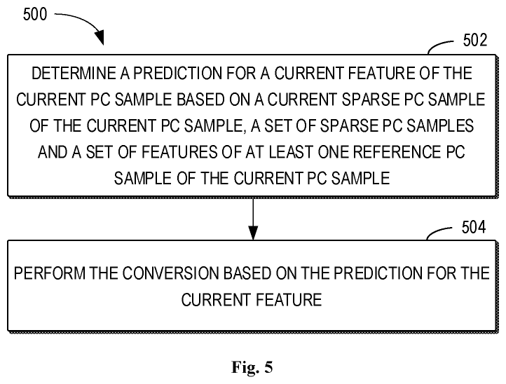

FIG. 5 illustrates a flowchart of a method 500 for point cloud processing in accordance with some embodiments of the present disclosure. The method 500 may be implemented during a conversion between a current PC sample of a point cloud sequence and a bitstream of the point cloud sequence. At 502, a prediction for a current feature of the current PC sample is determined based on a current sparse PC sample of the current PC sample, a set of sparse PC samples and a set of features of at least one reference PC sample of the current PC sample. For example, the at least one reference PC sample may be coded before the current PC sample.

In some embodiments, a feature of a PC sample and a sparse PC sample of the PC sample corresponds to each other, and may be generated by performing a downsampling process on the PC sample. The number of points in the sparse PC sample is less than the number of points in the PC sample. This will be descried in details below.

In some embodiments, the prediction for the current feature may be determined with a first neural network (NN) based model. As used herein, the term “model” is referred to as an association between an input and an output learned from training data, and thus a corresponding output may be generated for a given input after the training. The generation of the model may be based on a machine learning technique, such as neural network technique. In general, a NN-based model may be built, which receives input information and makes predictions based on the input information.

For example, the first NN-based model may comprise at least one sparse convolution, at least one sparse convolution on target coordinates, and/or the like.

At 504, the conversion is performed based on the prediction for the current feature. In some embodiments, the conversion may include encoding the current PC sample into the bitstream. In this case, a residual between the current feature and the prediction for the current feature may be determined as a difference between the current feature and the prediction. The residual and the current sparse PC sample may be encoded into the bitstream.

Alternatively or additionally, the conversion may include decoding the current PC sample from the bitstream. In this case, the residual between the current feature and the prediction for the current feature may be decoded from the bitstream, and the current sparse PC sample may be decoded from the bitstream. Moreover, the current PC sample may be reconstructed based on the prediction and the current sparse PC sample. This will be described in detail below.

In view of the above, a prediction for a current feature of the current PC sample is determined based on a current sparse PC sample of the current PC sample, a set of sparse PC samples and a set of features of at least one reference PC sample of the current PC sample. Moreover, the current PC sample is coded based on the prediction for the current feature. Compared with the conventional solution, the proposed method can advantageously make full use of the information of coded PC samples, so as to reduce the redundancy between information of current PC sample and information of coded PC samples. Thereby, the coding efficiency can be improved.

In some embodiments, the at least one reference PC sample may comprise a single reference PC sample. In one example embodiment, a downsampling process with at least one stage may be applied on the single reference PC sample. The set of sparse PC samples may comprise a sparse PC sample of the single reference PC sample generated at the last stage among the at least one stage, and the set of features may comprise a feature of the single reference PC sample generated at the last stage.

In one example, the prediction for the current feature may be determined by directly using the current sparse PC sample of the current PC sample, the sparse PC sample and the feature of the single reference PC sample. For example, the sparse PC sample and the feature of the single reference PC sample may be inputted to a NN-based model, and the NN-based model outputs the prediction for the current feature.

Alternatively, the prediction for the current feature may be determined by performing a refined secondary prediction process based on the current sparse PC sample of the current PC sample, the sparse PC sample and the feature of the single reference PC sample. By way of example rather than limitation, an initial prediction for the current feature may be generated based on the current sparse PC sample of the current PC sample, the sparse PC sample and the feature of the single reference PC sample. Furthermore, a secondary prediction for the current feature may be generated based on the initial prediction for the current feature and the feature of the single reference PC sample, to obtain the prediction for the current feature. The secondary prediction may be regarded as a refinement of the initial prediction. Thereby, the quality of the prediction can be improved.

In a further example embodiment, a downsampling process with a plurality of stages may be applied on the single reference PC sample. The set of sparse PC samples may comprise more than one sparse PC sample of the single reference PC sample generated at more than one stage among the plurality of stages, and the set of features may comprise more than one feature of the single reference PC sample generated at the more than one stage.

In one example, a sparse PC sample and a feature of the single reference PC sample generated at a first stage among the more than one stage may be downsampled, the downsampled sparse PC sample and the downsampled feature may be aligned and fused with a sparse PC sample and a feature of the single reference PC sample generated at a second stage among the more than one stage, respectively. The second stage follows the first stage. In aid of the alignment, a mapping relationship between points in the downsampled sparse PC sample and points in the sparse PC sample for the second stage is established, and a mapping relationship between elements in the downsampled feature and elements in the feature for the second stage is established. Thereafter, points in the downsampled sparse PC sample and points in the sparse PC sample for the second stage can be fused to obtain a fused sparse PC sample. Similarly, elements in the downsampled feature and elements in the feature for the second stage can be fused to obtain a fused feature. The fuse operation may be implemented with accumulation, weighted sum, weighted average, or the like.

Moreover, the prediction for the current feature is determined based on the current sparse PC sample of the current PC sample, a fused sparse PC sample and a fused feature of the single reference PC sample at the last stage among the more than one stage.

In some further embodiments, the at least one reference PC sample may comprise a plurality of reference PC samples. For example, the number of the plurality of reference PC samples may be two, three, or the like. In one example embodiment, a downsampling process with at least one stage may be applied on the plurality of reference PC samples. The set of sparse PC samples may comprise sparse PC samples of the plurality of reference PC samples generated at the last stage among the at least one stage, and the set of features may comprise features of the plurality of reference PC samples generated at the last stage.

In one example, the prediction for the current feature may be determined by directly using the current sparse PC sample of the current PC sample, the sparse PC samples and the features of the plurality of reference PC samples. By way of example rather than limitation, the sparse PC samples of the plurality of reference PC samples may be fused, and the features of the plurality of reference PC samples may be fused. The prediction for the current feature may be generated based on the current sparse PC sample of the current PC sample, the fused sparse PC samples and the fused features.

In another example, the prediction for the current feature may be determined by performing a refined secondary prediction process based on the current sparse PC sample of the current PC sample, the sparse PC samples and the features of the plurality of reference PC samples. Assuming that the plurality of reference PC samples comprises a first reference PC sample and a second reference PC sample. A first prediction for the current feature may be generated based on the current sparse PC sample of the current PC sample, a sparse PC sample and a feature of the first reference PC sample. A second prediction for the current feature may be generated based on the current sparse PC sample of the current PC sample, a sparse PC sample and a feature of the second reference PC sample. Moreover, the prediction for the current feature may be generated based on a result of fusing the first prediction and the second prediction. It should be understood that the above illustrations are described merely for purpose of description. The scope of the present disclosure is not limited in this respect.

In some further embodiments, a downsampling process with a plurality of stages may be applied on the plurality of reference PC samples. The set of sparse PC samples may comprise more than one sparse PC sample of the plurality of reference PC samples generated at more than one stage among the plurality of stages, and the set of features may comprise more than one feature of the plurality of reference PC samples generated at the more than one stage.

For example, sparse PC samples and features of the plurality of reference PC samples generated at a first stage among the more than one stage may be downsampled. The downsampled sparse PC samples and the downsampled features may be aligned and fused with sparse PC samples and features of the plurality of reference PC samples generated at a second stage among the more than one stage, respectively. The second stage follows the first stage. The above-described operations may be performed repeated for the more than stage, and the prediction for the current feature may be determined based on the current sparse PC sample of the current PC sample, a fused sparse PC sample and a fused feature at the last stage among the more than one stage.

In some embodiments, the method 500 may further comprise: obtaining the current sparse PC sample and the current feature by performing a first downsampling process on the current PC sample. In one example embodiment, the first downsampling process may be not based on machine learning. For example, the first downsampling process may comprise a furthest distance point sampling, a uniform sampling process, and/or the like.

In another example embodiment, the first downsampling process may be based on machine learning. For example, the first downsampling process may be applied with a second NN-based model. In some embodiments, the first downsampling process may comprise a plurality of stages. By way of example, the number of the plurality of stages may be 2, 3, 4, or the like.

In some embodiments, a sparse PC sample and a feature of the current PC sample that are generated at any of the plurality of stages may be outputted. Additionally or alternatively, sparse PC samples and features of the current PC sample that are generated at all of the plurality of stages may be outputted. For example, the current sparse PC sample may be determined as a sparse PC sample of the current PC sample that are generated at the last stage among the plurality of stages, and the current feature may be determined as a feature of the current PC sample that are generated at the last stage.

In some embodiments, the second NN-based model may comprise at least one sparse convolution. For example, a step size of the at least one sparse convolution may be 2, 3 or the like. The step size of the at least one sparse convolution may be predetermined or indicated in the bitstream.

In some embodiments, the method 500 may further comprise: obtaining the set of sparse PC samples and the set of features of the at least one reference PC sample by performing a second downsampling process on the at least one reference PC sample. By way of example rather than limitation, the second downsampling process may be based on machine learning. For example, the second downsampling process may be applied with a third NN-based model.

In some embodiments, the second downsampling process may comprise a plurality of stages. For example, the number of the plurality of stages may be 2, 3, 4 or the like. In one example embodiment, a sparse PC sample and a feature of the at least one reference PC sample that are generated at one or more of the plurality of stages may be outputted. Alternatively, sparse PC samples and features of the at least one reference PC sample that are generated at all of the plurality of stages may be outputted.

In some embodiments, the set of sparse PC samples of the at least one reference PC sample may comprise sparse PC samples of the at least one reference PC sample that are generated at the last two stages among the plurality of stages. In addition, the set of features of the at least one reference PC sample may comprise features of the at least one reference PC sample that are generated at the last two stages.

In some embodiments, the third NN-based model may comprise at least one sparse convolution. For example, a step size of the at least one sparse convolution may be 2. The step size of the at least one sparse convolution may be predetermined or indicated in the bitstream.

In some embodiments, the current sparse PC sample may be encoded into the bitstream. Additionally or alternatively, the current sparse PC sample may be decoded from the bitstream. For example, the current sparse PC sample may be coded with a point cloud codec. The point cloud codec may be based on Geometry-based Point Cloud Compression (G-PCC), Video-based Point Cloud Compression (V-PCC), Draco, or the like.

In some embodiments, a residual between the current feature and the prediction for the current feature may be encoded into the bitstream. Additionally or alternatively, the residual may be decoded from the bitstream. For example, the residual may be coded with fixed-length coding, unary coding, or truncated unary coding. The residual may be coded in a predictive way.

In some embodiments, at 504, the current PC sample may be reconstructed based on the prediction for the current feature and coordinates of the current sparse PC s ample. For example, the current feature may be obtained by adding the prediction for the current feature and a residual obtained from the bitstream. Furthermore, a upsampling process may be performed on the current sparse PC sample and the current feature to reconstruct the current PC sample.

In some embodiments, the upsampling process may comprise a single upsampling operation. Alternatively, the upsampling process may comprise a plurality of upsampling operations. For example, the number of the plurality of upsampling operations may be 2, 3, 5 or the like. In one example, the number of the plurality of upsampling operations may be predetermined. In another example, the number of the plurality of upsampling operations may be indicated in the bitstream. For example, the number of the plurality of upsampling operations may be coded with fixed-length coding, unary coding, or truncated unary coding. The number of the plurality of upsampling operations may be coded in a predictive way.

In some embodiments, the upsampling process may be implemented with a fourth NN-based model. By way of example rather than limitation, the fourth NN-based model may comprise at least one sparse convolution-based generative convolution. For example, the fourth NN-based model may be trained with multi-stage loss functions with different granularities. In one example, a binary cross-entropy value may be used as a loss function in a first stage.

In some embodiments, the number of points used in a loss function may be different for different stages. For example, the number of points used in a loss function for each stage may be indicated with at least one indication. The at least one indication may be predetermined or indicated in the bitstream.

By way of example rather than limitation, the fourth NN-based model may be trained with 3-stage loss functions. In this case, the at least one indication may comprise M, N and K. M % points of a PC sample obtained by voxel sampling from an original PC sample may be used in a loss function for the first stage, N % points of a PC sample obtained by voxel sampling from the original PC sample may be used in a loss function for the second stage, K % points of a PC sample obtained by voxel sampling from the original PC sample may be used in a loss function for the last stage. Each of M, N and K may be a non-negative number. In one example, M may be smaller than N, and N may be smaller than K. For example, M may be equal to 12.5, N may be equal to 50, and K may be equal to 100. It should be understood that the above illustrations are described merely for purpose of description, and the specific values recited herein are intended to be exemplary rather than limiting the scope of the present disclosure. The scope of the present disclosure is not limited in this respect.

In some embodiments, whether to and/or how to apply the method may be indicated in the bitstream at one of the following: a frame level, a tile level, a slice level, or an octree level. Additionally or alternatively, whether to and/or how to apply the method may be dependent on coded information of the current PC sample.

In some embodiments, the proposed method may be used to code geometry information of the point cloud sequence, such as coordinates of points in the point cloud sequence. In this case, only geometry information of the point cloud sequence is coded and signaled in the bitstream. Alternatively, the proposed method may also be used to code geometry information and attribute information of the point cloud sequence. The scope of the present disclosure is not limited in this respect.

In view of the above, the solutions in accordance with some embodiments of the present disclosure can advantageously improve coding efficiency and coding quality.

According to further embodiments of the present disclosure, a non-transitory computer-readable recording medium is provided. The non-transitory computer-readable recording medium stores a bitstream of a point cloud sequence which is generated by a method performed by an apparatus for point cloud processing. The method comprises: determining a prediction for a current feature of a current PC sample of a point cloud sequence based on a current sparse PC sample of the current PC sample, a set of sparse PC samples and a set of features of at least one reference PC sample of the current PC sample; and generating the bitstream based on the prediction for the current feature.

According to still further embodiments of the present disclosure, a method for storing bitstream of a point cloud sequence is provided. The method comprises: determining a prediction for a current feature of a current PC sample of a point cloud sequence based on a current sparse PC sample of the current PC sample, a set of sparse PC samples and a set of features of at least one reference PC sample of the current PC sample; generating the bitstream based on the prediction for the current feature; and storing the bitstream in a non-transitory computer-readable recording medium.

Implementations of the present disclosure can be described in view of the following clauses, the features of which can be combined in any reasonable manner.

Clause 1. A method for point cloud processing, comprising: determining, for a conversion between a current point cloud (PC) sample of a point cloud sequence and a bitstream of the point cloud sequence, a prediction for a current feature of the current PC sample based on a current sparse PC sample of the current PC sample, a set of sparse PC samples and a set of features of at least one reference PC sample of the current PC sample; and performing the conversion based on the prediction for the current feature.

Clause 2. The method of clause 1, wherein the at least one reference PC sample comprises a single reference PC sample.

Clause 3. The method of clause 2, wherein a downsampling process with at least one stage is applied on the single reference PC sample, the set of sparse PC samples comprises a sparse PC sample of the single reference PC sample generated at the last stage among the at least one stage, and the set of features comprises a feature of the single reference PC sample generated at the last stage.

Clause 4. The method of clause 3, wherein the prediction for the current feature is determined by directly using the current sparse PC sample of the current PC sample, the sparse PC sample and the feature of the single reference PC sample.

Clause 5. The method of clause 3, wherein the prediction for the current feature is determined by performing a refined secondary prediction process based on the current sparse PC sample of the current PC sample, the sparse PC sample and the feature of the single reference PC sample.

Clause 6. The method of clause 3, wherein determining the prediction for the current feature comprises: generating an initial prediction for the current feature based on the current sparse PC sample of the current PC sample, the sparse PC sample and the feature of the single reference PC sample; and generating a secondary prediction for the current feature based on the initial prediction for the current feature and the feature of the single reference PC sample, to obtain the prediction for the current feature.

Clause 7. The method of any of clauses 3-6, wherein the prediction for the current feature is determined with a first neural network (NN) based model.

Clause 8. The method of clause 7, wherein the first NN-based model comprises at least one sparse convolution or at least one sparse convolution on target coordinates.

Clause 9. The method of clause 2, wherein a downsampling process with a plurality of stages is applied on the single reference PC sample, and the set of sparse PC samples comprises more than one sparse PC sample of the single reference PC sample generated at more than one stage among the plurality of stages, and the set of features comprises more than one feature of the single reference PC sample generated at the more than one stage.

Clause 10. The method of clause 9, wherein a sparse PC sample and a feature of the single reference PC sample generated at a first stage among the more than one stage are downsampled, the downsampled sparse PC sample and the downsampled feature are aligned and fused with a sparse PC sample and a feature of the single reference PC sample generated at a second stage among the more than one stage, respectively, and the second stage follows the first stage.

Clause 11. The method of clause 10, wherein the prediction for the current feature is determined based on the current sparse PC sample of the current PC sample, a fused sparse PC sample and a fused feature of the single reference PC sample at the last stage among the more than one stage.

Clause 12. The method of any of clauses 9-11, wherein the prediction for the current feature is determined with a first neural network (NN) based model.

Clause 13. The method of clause 12, wherein the first NN-based model comprises at least one sparse convolution or at least one sparse convolution on target coordinates.

Clause 14. The method of clause 1, wherein the at least one reference PC sample comprises a plurality of reference PC samples.

Clause 15. The method of clause 14, wherein the number of the plurality of reference PC samples is two.

Clause 16. The method of any of clauses 14-15, wherein a downsampling process with at least one stage is applied on the plurality of reference PC samples, the set of sparse PC samples comprises sparse PC samples of the plurality of reference PC samples generated at the last stage among the at least one stage, and the set of features comprises features of the plurality of reference PC samples generated at the last stage.

Clause 17. The method of clause 16, wherein the prediction for the current feature is determined by directly using the current sparse PC sample of the current PC sample, the sparse PC samples and the features of the plurality of reference PC samples.

Clause 18. The method of clause 17, wherein determining the prediction for the current feature comprises: fusing the sparse PC samples of the plurality of reference PC samples; fusing the features of the plurality of reference PC samples; and generating the prediction for the current feature based on the current sparse PC sample of the current PC sample, the fused sparse PC samples and the fused features.

Clause 19. The method of clause 16, wherein the prediction for the current feature is determined by performing a refined secondary prediction process based on the current sparse PC sample of the current PC sample, the sparse PC samples and the features of the plurality of reference PC samples.

Clause 20. The method of clause 16, wherein the plurality of reference PC samples comprises a first reference PC sample and a second reference PC sample, and determining the prediction for the current feature comprises: generating a first prediction for the current feature based on the current sparse PC sample of the current PC sample, a sparse PC sample and a feature of the first reference PC sample; generating a second prediction for the current feature based on the current sparse PC sample of the current PC sample, a sparse PC sample and a feature of the second reference PC sample; and generating the prediction for the current feature based on a result of fusing the first prediction and the second prediction.

Clause 21. The method of any of clauses 14-15, wherein a downsampling process with a plurality of stages is applied on the plurality of reference PC samples, and the set of sparse PC samples comprises more than one sparse PC sample of the plurality of reference PC samples generated at more than one stage among the plurality of stages, and the set of features comprises more than one feature of the plurality of reference PC samples generated at the more than one stage.

Clause 22. The method of clause 21, wherein sparse PC samples and features of the plurality of reference PC samples generated at a first stage among the more than one stage are downsampled, the downsampled sparse PC samples and the downsampled features are aligned and fused with sparse PC samples and features of the plurality of reference PC samples generated at a second stage among the more than one stage, respectively, and the second stage follows the first stage.

Clause 23. The method of clause 22, wherein the prediction for the current feature is determined based on the current sparse PC sample of the current PC sample, a fused sparse PC sample and a fused feature at the last stage among the more than one stage.

Clause 24. The method of any of clauses 15-23, wherein the prediction for the current feature is determined with a neural network (NN) based model.

Clause 25. The method of any of clauses 1-24, further comprising: obtaining the current sparse PC sample and the current feature by performing a first downsampling process on the current PC sample.

Clause 26. The method of clause 25, wherein the first downsampling process is not based on machine learning.

Clause 27. The method of clause 26, wherein the first downsampling process comprises a furthest distance point sampling or a uniform sampling process.

Clause 28. The method of clause 25, wherein the first downsampling process is based on machine learning.

Clause 29. The method of clause 28, wherein the first downsampling process is applied with a second NN-based model.

Clause 30. The method of any of claim 28-29, wherein the first downsampling process comprises a plurality of stages.

Clause 31. The method of clause 30, wherein the number of the plurality of stages is 3.

Clause 32. The method of any of clauses 30-31, wherein a sparse PC sample and a feature of the current PC sample that are generated at any of the plurality of stages are outputted.

Clause 33. The method of any of clauses 30-32, wherein the current sparse PC sample is determined as a sparse PC sample of the current PC sample that is generated at the last stage among the plurality of stages, and the current feature is determined as a feature of the current PC sample that is generated at the last stage.

Clause 34. The method of any of clauses 30-33, wherein sparse PC samples and features of the current PC sample that are generated at all of the plurality of stages are outputted.

Clause 35. The method of clause 29, wherein the second NN-based model comprises at least one sparse convolution.

Clause 36. The method of clause 35, wherein a step size of the at least one sparse convolution is 2.

Clause 37. The method of any of clauses 35-36, wherein a step size of the at least one sparse convolution is predetermined or indicated in the bitstream.

Clause 38. The method of any of clauses 1-37, wherein the at least one reference PC sample are coded before the current PC sample.

Clause 39. The method of clause 38, wherein the at least one reference PC sample comprises two PC samples coded before the current PC sample.

Clause 40. The method of any of clauses 1-39, further comprising: obtaining the set of sparse PC samples and the set of features of the at least one reference PC sample by performing a second downsampling process on the at least one reference PC sample.

Clause 41. The method of clause 40, wherein the second downsampling process is based on machine learning.

Clause 42. The method of clause 41, wherein the second downsampling process is applied with a third NN-based model.

Clause 43. The method of any of clauses 41-42, wherein the second downsampling process comprises a plurality of stages.

Clause 44. The method of clause 43, wherein the number of the plurality of stages is 3.

Clause 45. The method of any of clauses 43-44, wherein a sparse PC sample and a feature of the at least one reference PC sample that are generated at one or more of the plurality of stages are outputted.

Clause 46. The method of any of clauses 43-45, wherein the set of sparse PC samples of the at least one reference PC sample comprise sparse PC samples of the at least one reference PC sample that are generated at the last two stages among the plurality of stages, and the set of features of the at least one reference PC sample comprise features of the at least one reference PC sample that are generated at the last two stages.

Clause 47. The method of any of clauses 43-46, wherein sparse PC samples and features of the at least one reference PC sample that are generated at all of the plurality of stages are outputted.

Clause 48. The method of clause 42, wherein the third NN-based model comprises at least one sparse convolution.

Clause 49. The method of clause 48, wherein a step size of the at least one sparse convolution is 2.

Clause 50. The method of any of clauses 48-49, wherein a step size of the at least one sparse convolution is predetermined or indicated in the bitstream.

Clause 51. The method of any of clauses 1-50, wherein the current sparse PC sample is encoded into the bitstream or decoded from the bitstream.

Clause 52. The method of clause 51, wherein the current sparse PC sample is coded with a point cloud codec.

Clause 53. The method of clause 52, wherein the point cloud codec is based on Geometry-based Point Cloud Compression (G-PCC), Video-based Point Cloud Compression (V-PCC) or Draco.

Clause 54. The method of any of clauses 1-53, wherein a residual between the current feature and the prediction for the current feature is encoded into the bitstream or decoded from the bitstream.

Clause 55. The method of clause 54, wherein the residual is coded with fixed-length coding, unary coding, or truncated unary coding.

Clause 56. The method of clause 55, wherein the residual is coded in a predictive way.

Clause 57. The method of any of clauses 1-56, wherein performing the conversion comprises: reconstructing the current PC sample based on the prediction for the current feature and coordinates of the current sparse PC sample.

Clause 58. The method of clause 57, wherein reconstructing the current PC sample comprises: obtaining the current feature by adding the prediction for the current feature and a residual obtained from the bitstream.

Clause 59. The method of clause 58, wherein reconstructing the current PC sample further comprises: performing a upsampling process on the current sparse PC sample and the current feature to reconstruct the current PC sample.

Clause 60. The method of clause 59, wherein the upsampling process comprises a single upsampling operation.

Clause 61. The method of clause 59, wherein the upsampling process comprises a plurality of upsampling operations.

Clause 62. The method of clause 61, wherein the number of the plurality of upsampling operations is 3.

Clause 63. The method of any of clauses 61-62, wherein the number of the plurality of upsampling operations is predetermined.

Clause 64. The method of any of clauses 61-62, wherein the number of the plurality of upsampling operations is indicated in the bitstream.

Clause 65. The method of clause 64, wherein the number of the plurality of upsampling operations is coded with fixed-length coding, unary coding, or truncated unary coding.

Clause 66. The method of clause 64, wherein the number of the plurality of upsampling operations is coded in a predictive way.

Clause 67. The method of any of clauses 59-66, wherein the upsampling process is implemented with a fourth NN-based model.

Clause 68. The method of clause 67, wherein the fourth NN-based model comprises at least one sparse convolution-based generative convolution.

Clause 69. The method of any of clauses 67-68, wherein the fourth NN-based model is trained with multi-stage loss functions with different granularities.

Clause 70. The method of clause 69, wherein a binary cross-entropy value is used as a loss function in a first stage.

Clause 71. The method of any of clauses 69-70, wherein the number of points used in a loss function is different for different stages.

Clause 72. The method of any of clauses 69-70, wherein the number of points used in a loss function for each stage is indicated with at least one indication.

Clause 73. The method of clause 72, wherein the fourth NN-based model is trained with 3-stage loss functions, the at least one indication comprises M, N and K, M % points of a PC sample obtained by voxel sampling from an original PC sample is used in a loss function for the first stage, N % points of a PC sample obtained by voxel sampling from the original PC sample is used in a loss function for the second stage, K % points of a PC sample obtained by voxel sampling from the original PC sample is used in a loss function for the last stage, and each of M, N and K is a non-negative number.

Clause 74. The method of clause 73, wherein M is smaller than N, and N is smaller than K.

Clause 75. The method of any of clauses 72-74, wherein the at least one indication is predetermined or indicated in the bitstream.

Clause 76. The method of any of clauses 1-75, wherein whether to and/or how to apply the method is indicated in the bitstream at one of the following: a frame level, a tile level, a slice level, or an octree level.

Clause 77. The method of any of clauses 1-76, wherein whether to and/or how to apply the method is dependent on coded information of the current PC sample.

Clause 78. The method of any of clauses 1-77, wherein a PC sample is one of the following: a frame, a picture, a slice, a sub-frame, a sub-picture, a tile, or a segment.

Clause 79. The method of any of clauses 1-78, wherein the conversion includes encoding the current PC sample into the bitstream.

Clause 80. The method of any of clauses 1-78, wherein the conversion includes decoding the current PC sample from the bitstream.

Clause 81. An apparatus for point cloud processing comprising a processor and a non-transitory memory with instructions thereon, wherein the instructions upon execution by the processor, cause the processor to perform a method in accordance with any of clauses 1-80.

Clause 82. A non-transitory computer-readable storage medium storing instructions that cause a processor to perform a method in accordance with any of clauses 1-80.

Clause 83. A non-transitory computer-readable recording medium storing a bitstream of a point cloud sequence which is generated by a method performed by an apparatus for point cloud processing, wherein the method comprises: determining a prediction for a current feature of a current PC sample of a point cloud sequence based on a current sparse PC sample of the current PC sample, a set of sparse PC samples and a set of features of at least one reference PC sample of the current PC sample; and generating the bitstream based on the prediction for the current feature.

Clause 84. A method for storing a bitstream of a point cloud sequence, comprising: determining a prediction for a current feature of a current PC sample of a point cloud sequence based on a current sparse PC sample of the current PC sample, a set of sparse PC samples and a set of features of at least one reference PC sample of the current PC sample; generating the bitstream based on the prediction for the current feature; and storing the bitstream in a non-transitory computer-readable recording medium.

### Example Device

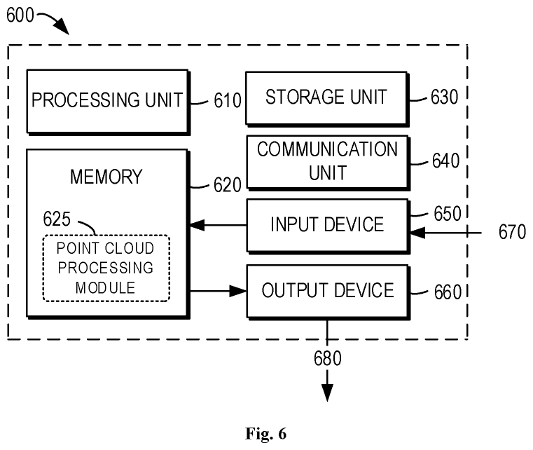

FIG. 6 illustrates a block diagram of a computing device 600 in which various embodiments of the present disclosure can be implemented. The computing device 600 may be implemented as or included in the source device 110 (or the GPCC encoder 116 or 200) or the destination device 120 (or the GPCC decoder 126 or 300).

It would be appreciated that the computing device 600 shown in FIG. 6 is merely for purpose of illustration, without suggesting any limitation to the functions and scopes of the embodiments of the present disclosure in any manner.

As shown in FIG. 6, the computing device 600 includes a general-purpose computing device 600. The computing device 600 may at least comprise one or more processors or processing units 610, a memory 620, a storage unit 630, one or more communication units 640, one or more input devices 650, and one or more output devices 660.

In some embodiments, the computing device 600 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 600 can support any type of interface to a user (such as “wearable” circuitry and the like).

The processing unit 610 may be a physical or virtual processor and can implement various processes based on programs stored in the memory 620. In a multi-processor system, multiple processing units execute computer executable instructions in parallel so as to improve the parallel processing capability of the computing device 600. The processing unit 610 may also be referred to as a central processing unit (CPU), a microprocessor, a controller or a microcontroller.

The computing device 600 typically includes various computer storage medium. Such medium can be any medium accessible by the computing device 600, including, but not limited to, volatile and non-volatile medium, or detachable and non-detachable medium. The memory 620 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 630 may be any detachable or non-detachable medium and may include a machine-readable medium such as a memory, flash memory drive, magnetic disk or another other media, which can be used for storing information and/or data and can be accessed in the computing device 600.

The computing device 600 may further include additional detachable/non-detachable, volatile/non-volatile memory medium. Although not shown in FIG. 6, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 640 communicates with a further computing device via the communication medium. In addition, the functions of the components in the computing device 600 can be implemented by a single computing cluster or multiple computing machines that can communicate via communication connections. Therefore, the computing device 600 can operate in a networked environment using a logical connection with one or more other servers, networked personal computers (PCs) or further general network nodes.

The input device 650 may be one or more of a variety of input devices, such as a mouse, keyboard, tracking ball, voice-input device, and the like. The output device 660 may be one or more of a variety of output devices, such as a display, loudspeaker, printer, and the like. By means of the communication unit 640, the computing device 600 can further communicate with one or more external devices (not shown) such as the storage devices and display device, with one or more devices enabling the user to interact with the computing device 600, or any devices (such as a network card, a modem and the like) enabling the computing device 600 to communicate with one or more other computing devices, if required. Such communication can be performed via input/output (I/O) interfaces (not shown).

In some embodiments, instead of being integrated in a single device, some or all components of the computing device 600 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 600 may be used to implement point cloud encoding/decoding in embodiments of the present disclosure. The memory 620 may include one or more point cloud processing modules 625 having one or more program instructions. These modules are accessible and executable by the processing unit 610 to perform the functionalities of the various embodiments described herein.

In the example embodiments of performing point cloud encoding, the input device 650 may receive point cloud data as an input 670 to be encoded. The point cloud data may be processed, for example, by the point cloud processing module 625, to generate an encoded bitstream. The encoded bitstream may be provided via the output device 660 as an output 680.

In the example embodiments of performing point cloud decoding, the input device 650 may receive an encoded bitstream as the input 670. The encoded bitstream may be processed, for example, by the point cloud processing module 625, to generate decoded point cloud data. The decoded point cloud data may be provided via the output device 660 as the output 680.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for point cloud processing, comprising:
determining, for a conversion between a current point cloud (PC) sample of a point cloud sequence and a bitstream of the point cloud sequence, a prediction for a current feature of the current PC sample based on a current sparse PC sample of the current PC sample, a set of sparse PC samples and a set of features of at least one reference PC sample of the current PC sample; and
performing the conversion based on the prediction for the current feature.

2. The method of claim 1, wherein the at least one reference PC sample comprises a single reference PC sample, or
wherein the at least one reference PC sample comprises a plurality of reference PC samples.

3. The method of claim 2, wherein a downsampling process with at least one stage is applied on the single reference PC sample, the set of sparse PC samples comprises a sparse PC sample of the single reference PC sample generated at the last stage among the at least one stage, and the set of features comprises a feature of the single reference PC sample generated at the last stage, or
wherein a downsampling process with a plurality of stages is applied on the single reference PC sample, and the set of sparse PC samples comprises more than one sparse PC sample of the single reference PC sample generated at more than one stage among the plurality of stages, and the set of features comprises more than one feature of the single reference PC sample generated at the more than one stage, or
wherein the number of the plurality of reference PC samples is two, or
wherein a downsampling process with at least one stage is applied on the plurality of reference PC samples, the set of sparse PC samples comprises sparse PC samples of the plurality of reference PC samples generated at the last stage among the at least one stage, and the set of features comprises features of the plurality of reference PC samples generated at the last stage, or
wherein a downsampling process with a plurality of stages is applied on the plurality of reference PC samples, and the set of sparse PC samples comprises more than one sparse PC sample of the plurality of reference PC samples generated at more than one stage among the plurality of stages, and the set of features comprises more than one feature of the plurality of reference PC samples generated at the more than one stage.

4. The method of claim 3, wherein the prediction for the current feature is determined by directly using the current sparse PC sample of the current PC sample, the sparse PC sample and the feature of the single reference PC sample, or
wherein the prediction for the current feature is determined by performing a refined secondary prediction process based on the current sparse PC sample of the current PC sample, the sparse PC sample and the feature of the single reference PC sample, or
wherein determining the prediction for the current feature comprises:
generating an initial prediction for the current feature based on the current sparse PC sample of the current PC sample, the sparse PC sample and the feature of the single reference PC sample; and
generating a secondary prediction for the current feature based on the initial prediction for the current feature and the feature of the single reference PC sample, to obtain the prediction for the current feature, or wherein the prediction for the current feature is determined with a first neural network (NN) based model, or
wherein a sparse PC sample and a feature of the single reference PC sample generated at a first stage among the more than one stage are downsampled, the downsampled sparse PC sample and the downsampled feature are aligned and fused with a sparse PC sample and a feature of the single reference PC sample generated at a second stage among the more than one stage, respectively, and the second stage follows the first stage, and
wherein the prediction for the current feature is determined based on the current sparse PC sample of the current PC sample, a fused sparse PC sample and a fused feature of the single reference PC sample at the last stage among the more than one stage, or
wherein the prediction for the current feature is determined with a first neural network (NN) based model, and wherein the first NN-based model comprises at least one sparse convolution or at least one sparse convolution on target coordinates, or
wherein the prediction for the current feature is determined by directly using the current sparse PC sample of the current PC sample, the sparse PC samples and the features of the plurality of reference PC samples, or
wherein the prediction for the current feature is determined by performing a refined secondary prediction process based on the current sparse PC sample of the current PC sample, the sparse PC samples and the features of the plurality of reference PC samples, or
wherein the plurality of reference PC samples comprises a first reference PC sample and a second reference PC sample, and determining the prediction for the current feature comprises:
generating a first prediction for the current feature based on the current sparse PC sample of the current PC sample, a sparse PC sample and a feature of the first reference PC sample;
generating a second prediction for the current feature based on the current sparse PC sample of the current PC sample, a sparse PC sample and a feature of the second reference PC sample; and
generating the prediction for the current feature based on a result of fusing the first prediction and the second prediction, or
wherein sparse PC samples and features of the plurality of reference PC samples generated at a first stage among the more than one stage are downsampled, the downsampled sparse PC samples and the downsampled features are aligned and fused with sparse PC samples and features of the plurality of reference PC samples generated at a second stage among the more than one stage, respectively, and the second stage follows the first stage, or
wherein the prediction for the current feature is determined with a neural network (NN) based model.

5. The method of claim 1, wherein the method further comprises:
obtaining the current sparse PC sample and the current feature by performing a first downsampling process on the current PC sample, or
wherein the method further comprises:
obtaining the set of sparse PC samples and the set of features of the at least one reference PC sample by performing a second downsampling process on the at least one reference PC sample.

6. The method of claim 5, wherein the first downsampling process is not based on machine learning, and wherein the first downsampling process comprises a furthest distance point sampling or a uniform sampling process, or
wherein the first downsampling process is based on machine learning, and wherein the first downsampling process is applied with a second NN-based model, and wherein the first downsampling process comprises a plurality of stages.

7. The method of claim 6, wherein the number of the plurality of stages is 3, or
wherein a sparse PC sample and a feature of the current PC sample that are generated at any of the plurality of stages are outputted, or
wherein the current sparse PC sample is determined as a sparse PC sample of the current PC sample that is generated at the last stage among the plurality of stages, and the current feature is determined as a feature of the current PC sample that is generated at the last stage, or
wherein sparse PC samples and features of the current PC sample that are generated at all of the plurality of stages are outputted, or
wherein the second NN-based model comprises at least one sparse convolution, and
wherein a step size of the at least one sparse convolution is 2, or is predetermined or indicated in the bitstream.

8. The method of claim 5, wherein the second downsampling process is based on machine learning, and
wherein the second downsampling process is applied with a third NN-based model, or wherein the second downsampling process comprises a plurality of stages, and wherein the number of the plurality of stages is 3, or wherein a sparse PC sample and a feature of the at least one reference PC sample that are generated at one or more of the plurality of stages are outputted, or
wherein the set of sparse PC samples of the at least one reference PC sample comprise sparse PC samples of the at least one reference PC sample that are generated at the last two stages among the plurality of stages, and the set of features of the at least one reference PC sample comprise features of the at least one reference PC sample that are generated at the last two stages, or
wherein sparse PC samples and features of the at least one reference PC sample that are generated at all of the plurality of stages are outputted.

9. The method of claim 1, wherein the current sparse PC sample is encoded into the bitstream or decoded from the bitstream, or
wherein a residual between the current feature and the prediction for the current feature is encoded into the bitstream or decoded from the bitstream.

10. The method of claim 9, wherein the current sparse PC sample is coded with a point cloud codec, and
the point cloud codec is based on Geometry-based Point Cloud Compression (G-PCC), Video-based Point Cloud Compression (V-PCC) or Draco, or
wherein the residual is coded with fixed-length coding, unary coding, or truncated unary coding, and
wherein the residual is coded in a predictive way.

11. The method of claim 1, wherein performing the conversion comprises:
reconstructing the current PC sample based on the prediction for the current feature and coordinates of the current sparse PC sample.

12. The method of claim 11, wherein reconstructing the current PC sample comprises:
obtaining the current feature by adding the prediction for the current feature and a residual obtained from the bitstream; and
performing a upsampling process on the current sparse PC sample and the current feature to reconstruct the current PC sample.

13. The method of claim 12, wherein the upsampling process comprises a single upsampling operation, or
wherein the upsampling process comprises a plurality of upsampling operations, and wherein the number of the plurality of upsampling operations is 3, or is predetermined, or is indicated in the bitstream, or
wherein the upsampling process is implemented with a fourth NN-based model, and wherein the fourth NN-based model comprises at least one sparse convolution-based generative convolution, or is trained with multi-stage loss functions with different granularities.

14. The method of claim 13, wherein a binary cross-entropy value is used as a loss function in a first stage, or
wherein the number of points used in a loss function is different for different stages, or
wherein the number of points used in a loss function for each stage is indicated with at least one indication.

15. The method of claim 1, wherein whether to and/or how to apply the method is indicated in the bitstream at one of the following: a frame level, a tile level, a slice level, or an octree level, or
wherein whether to and/or how to apply the method is dependent on coded information of the current PC sample, or
wherein a PC sample is one of the following: a frame, a picture, a slice, a sub-frame, a sub-picture, a tile, or a segment, or
wherein the at least one reference PC sample are coded before the current PC sample, and wherein the at least one reference PC sample comprises two PC samples coded before the current PC sample.

16. The method of claim 1, wherein the conversion includes encoding the current PC sample into the bitstream.

17. The method of claim 1, wherein the conversion includes decoding the current PC sample from the bitstream.

18. The method of claim 1, wherein the conversion comprises: generating the bitstream from the point cloud sequence, and
the method further comprises: storing the bitstream in a non-transitory computer-readable recording medium.

19. An apparatus for point cloud processing comprising a processor and a non-transitory memory with instructions thereon, wherein the instructions upon execution by the processor, cause the processor to perform operations comprising:
determining, for a conversion between a current point cloud (PC) sample of a point cloud sequence and a bitstream of the point cloud sequence, a prediction for a current feature of the current PC sample based on a current sparse PC sample of the current PC sample, a set of sparse PC samples and a set of features of at least one reference PC sample of the current PC sample; and
performing the conversion based on the prediction for the current feature.

20. A non-transitory computer-readable storage medium storing instructions that cause a processor to perform operations comprising:
determining, for a conversion between a current point cloud (PC) sample of a point cloud sequence and a bitstream of the point cloud sequence, a prediction for a current feature of the current PC sample based on a current sparse PC sample of the current PC sample, a set of sparse PC samples and a set of features of at least one reference PC sample of the current PC sample; and
performing the conversion based on the prediction for the current feature.
